(19) United States
(12) Patent Application Publication
(10) Pub. No.: US 2026/0236773 A1
(43) Pub. Date: Aug. 13, 2026

(54) CONTROLLING AGENTS USING PROTO-GOAL PRUNING

(71) Applicant: DEEPMIND TECHNOLOGIES LIMITED, London (GB)

(72) Inventors: Tom Schaul, London (GB); Akhil Bagaria, Providence, RI (US)

(21) Appl. No.: 19/149,139

(22) PCT Filed: Jan. 18, 2024
(86) PCT No.: PCT/EP2024/051137

§ 371 Date: Jul. 18, 2025

Related U.S. Application Data
(60) Provisional application No. 63/439,841, filed on Jan. 18, 2023.

(51) Int. Cl. G06N 3/082

(52) U.S. Cl. CPC G06N 3/082

(57) ABSTRACT

Methods, systems, and apparatus, including computer programs encoded on a computer storage medium, for controlling agents using proto-goal pruning.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment to perform a task in the environment using a policy neural network. In particular, while training the neural network, the system selects which goal should be used to condition the policy neural network at any given time using proto-goal pruning.

Particular embodiments of the subject matter described in this specification can be implemented so as to realize one or more of the following advantages.

Exploration remains a significant challenge for many reinforcement learning systems, particularly in environments where simple novelty-based or coverage-seeking exploration strategies fail to cause an agent to effectively explore the environment.

This specification describes training a policy neural network that is used to control an agent by making use of proto-goals and, more specifically, proto-goal pruning. More specifically, proto-goal pruning is used to determine which goals to condition the policy neural network on when controlling the agent during training, i.e., to generate training data for training the policy neural network.

By making use of proto-goal pruning, the system can effectively cause the agent to explore the environment, even in challenging domains and complex environment where novelty-seeking and coverage-seeking behavior falls short. This results in the training of the policy neural network consuming fewer computational resources, i.e., because the agent attains good performance on the task far more quickly and the training therefore requires fewer training iterations. Moreover, the agent can achieve improved performance on the task, particularly when the task requires a thorough representation of the state space of the environment in order to be performed well.

In particular, the system performs proto-goal pruning to filter a potentially very large space of proto-goals to a smaller set of plausible goals and then to select a desirable goal from the set of plausible goals. By making use of the techniques described in this specification, the system can perform the pruning with minimal computational overhead and with minimal latency.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for controlling the agent at a given time step during a task episode performed during the training of the policy neural network.

FIG. 3 is a flow diagram of an example process for performing re-labeling during the training of the policy neural network.

FIG. 4 is a flow diagram of an example process for identifying reachable proto-goals.

FIG. 5 is a flow diagram of an example process for identifying controllable proto-goals.

FIG. 6 is a flow diagram of an example process for selecting a goal using novelty measures for proto-goals.

FIG. 7 shows an example of the operation of the system.

FIG. 8 shows an example of the performance of the described techniques relative to a baseline technique on a difficult exploration task.

FIG. 9 shows an example of the proto-goal space for an example task.

FIG. 10 shows an example architecture of the policy neural network when the observations received by the system include images.

Like reference numbers and designations in the various drawings indicate like elements.

### DETAILED DESCRIPTION

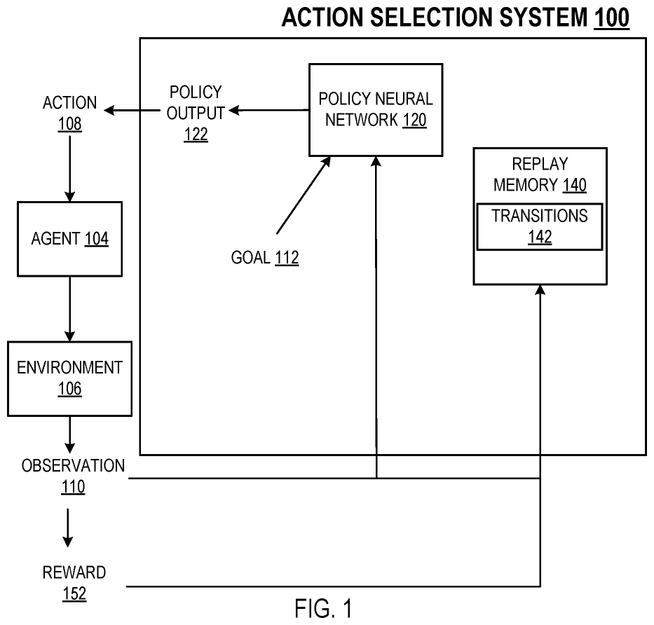

FIG. 1 shows an example action selection system 100. The action selection system 100 is an example of a system implemented as computer programs on one or more computers in one or more locations in which the systems, components, and techniques described below are implemented.

The action selection system 100 uses policy neural network 120 to control an agent 104 interacting with an environment 106 to perform a task in the environment 106.

Examples of agents, environments, and tasks will be described below.

When controlling the agent 104, the system 100 controls the agent 104 to accomplish a task by selecting actions 108 to be performed by the agent 104 at each of multiple time steps during the performance of an episode of the task.

An “episode” of a task is a sequence of interactions during which the agent attempts to perform an instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent 104 performs the action 108, the environment 106 transitions into a new state.

The observation 110 can include any appropriate information that characterizes the state of the environment. As one example, the observation 110 can include sensor readings from one or more sensors configured to sense the environment. For example, the observation 110 can include one or more images captured by one or more cameras, measurements from one or more proprioceptive sensors, and so on.

In some cases, the system 100 receives a task reward 152 from the environment in response to the agent performing the action.

Generally, the reward is a scalar numerical value and characterizes a progress of the agent towards completing the task.

As a particular example, the reward can be a sparse binary reward that is zero unless the task is successfully completed and one if the task is successfully completed as a result of the action performed.

As another particular example, the reward can be a dense reward that measures a progress of the agent towards completing the task as of individual observations received during the episode of attempting to perform the task, i.e., so that non-zero rewards can be and frequently are received before the task is successfully completed.

The policy neural network 120 is a “goal-conditioned” policy. That is, at any given step, the policy neural network 120 is conditioned on, i.e., receives as input, both a current observation 110 at the time step and a goal 112 that is being pursued by the agent 104 at the time step and generates as output a policy output 122 that defines an action to be performed by the agent at the time step, e.g., an action that the policy neural network 120 estimates should be performed by the agent 104 at the time step in order to accomplish the goal 112.

In one example, the policy output 122 may include a respective numerical probability value for each action in a fixed set. The system 100 can select the action 108, e.g., by sampling an action in accordance with the probability values for the action indices, or by selecting the action with the highest probability value.

In another example, the policy output 122 may include a respective Q-value for each action in the fixed set. The system 100 can process the Q-values (e.g., using a soft-max function) to generate a respective probability value for each action, which can be used to select the action 108 (as described earlier), or can select the action with the highest Q-value.

The Q-value for an action is an estimate of a return that would result from the agent 104 performing the action in response to the current observation 110 and thereafter selecting future actions performed by the agent 104 in accordance with current values of the parameters of the policy neural network 120 and conditioned on the current goal 112.

As another example, when the action space is continuous, the policy output 122 can include parameters of a probability distribution over the continuous action space and the system 100 can select the action 108 by sampling from the probability distribution or by selecting the mean action.

A continuous action space is one that contains an uncountable number of actions, i.e., where each action is represented as a vector having one or more dimensions and, for each dimension, the action vector can take any value that is within the range for the dimension and the only constraint is the precision of the numerical format used by the system.

As yet another example, when the action space is continuous the policy output 122 can include a regressed action, i.e., a regressed vector representing an action from the continuous space, and the system 100 can select the regressed action as the action 108 to be performed by the agent.

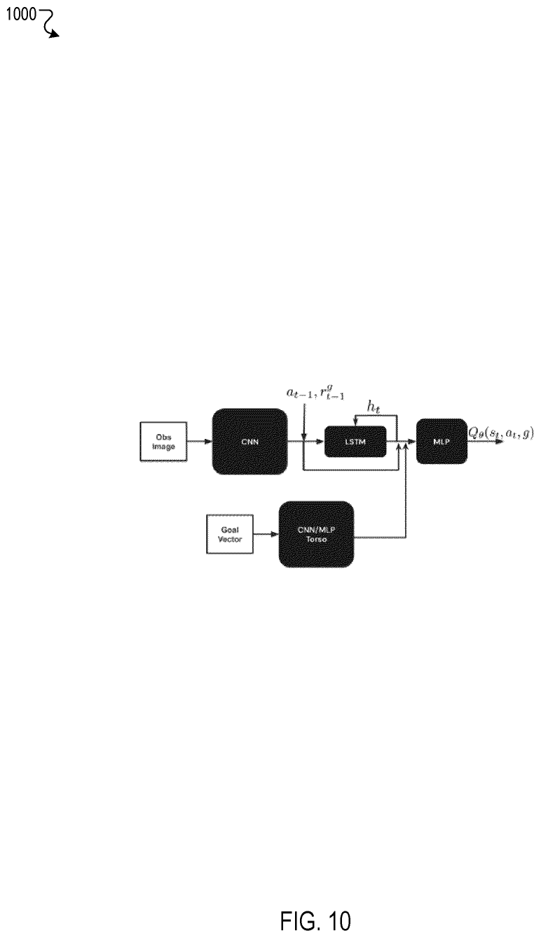

Example architectures of the policy neural network 120 are described below with reference to FIG. 10.

A “goal” 112 as used in this specification is a set of one or more proto-goals and is achieved when each of the proto-goals in the set is achieved. Thus, a goal may be considered as a composite, formed during a process as described below, of a selected sub-set that includes one or more of multiple elements, i.e., the proto-goals.

Each proto-goal corresponds to one or more properties of the environment 106 and is satisfied in a given state when the environment 106 has the one or more properties when in the given state. One or more of the proto-goals may, for example, be chosen by a human controller, e.g. based on intuition about salient properties of the environment (e.g. for typical tasks the agent might perform). In another example, if the observation 110 includes data from one or more sensors, then one or more corresponding proto-goals may be defined for each sensor, e.g. a proto-goal may be defined for each of a plurality of respective ranges which a numerical value output by the sensor might take; and/or, in the case of a sensor which outputs multiple numerical values (e.g. one or more intensity values for each pixel of a captured image), a corresponding property of the multiple numerical values (e.g. an average of intensity values for a pixels of first portion of the image exceeds an average of intensity values for pixels of a second, different portion of the image).

In some implementations, the properties include properties of observations or other data characterizing the given state of the environment 106. Examples of such properties include particular entities being referenced in text received from the environment 106, particular sounds being emitted from the environment 106, particular object attributes being observed of objects in the environment 106, and so on.

In some implementations, the properties include properties that are based on an output of a machine learning model that processes data characterizing the state of the environment 106. For example, these may be latent, learned properties of latent representations generated by an encoder neural network that encodes observations of states of the environment 106, e.g., that has been trained as part of an auto-encoder for encoding and reconstructing observations.

For example, each goal and proto-goal can be represented as a vector that includes a respective entry for each of a set of properties of the environment, with the entry for each property corresponding to the goal or proto-goal being equal to a first value, e.g., one, and the entries for the other properties being equal to a different value, e.g., zero.

Thus, for a proto-goal, the vector has value one for the one or more properties corresponding to the proto-goal and a value of zero for all other properties. For a goal that is a set of particular proto-goals, the vector has value one for each property that corresponds to any one of the particular proto-goals and a value of zero for any property that does not correspond to any of the particular proto-goals.

Thus, in this example, at each time step, the policy neural network 120 receives as input the input observation 110 and the vector representing the current goal 112.

After the policy neural network 120 is trained, the system 100 can cause the agent 104 to perform the task by conditioning the policy neural network 120 on a default goal, e.g., a vector that has a respective default value, e.g., zero, for each property, i.e., that indicates to the neural network that task rewards should be maximized by controlling the agent.

Alternatively, after the policy neural network 120 has been trained, the system 100 can cause the agent to further explore the environment or to explore a new environment, e.g., by selecting goals as described below, i.e., instead of always conditioning the policy neural network 120 on the default goal.

During training and as will be discussed in more detail below, in order to assist the agent 108 in effectively exploring the environment, the system 100 selects the goal 112 that will be used to condition the policy neural network 120 using proto-goal pruning. At a high level, to perform proto-goal pruning, the system 100 filters the proto-goals in the set of proto-goals based on plausibility and then selects one of the plausible proto-goals as the goal 112. The term “plausible” may mean that the proto-goal meets a plausibility criterion. The plausibility criterion may be defined based on one or more further criteria, e.g. a reachability criterion indicative of a numerical measure of a likelihood (estimated based on training data, as discussed below) of the environment reaching a state which exhibits the property/-ies associated with the proto-goal, and/or a controllability criterion indicative of a numerical measure of a degree to which the actions of the agent are statistically associated with whether the environment reaches a state which exhibits the property/-ies associated with the proto-goal.

The system 100 then uses the policy neural network 120 conditioned on the selected goal 112 in order to generate training data for later use in training the policy neural network 120.

In particular, the system 100 can control the agent across multiple iterations in order to generate transitions 142 to be added to a replay memory 140. Each transition is a dataset which includes (i) an observation characterizing a state of the environment 106, (ii) data identifying each proto-goal that was achieved when the environment 106 was in the state, and (iii) an action performed by the agent in response to the observation. Each transition will generally also include the task reward that was received at the corresponding time step.

The system 100 can periodically, e.g., at regular or irregular intervals, sample transitions 142 (or trajectories of transitions 142) from the replay memory 140 and then train the neural network 120 on the sampled transitions 142 through reinforcement learning.

The system 100 can use any appropriate reinforcement learning technique to train the policy neural network 120 to maximize expected task rewards 152 and, optionally, goal rewards (described below) or both using the transitions 142 and the corresponding rewards in the replay memory 140. Thus, by using proto-goal pruning to generate training data for training the policy neural network 120, the system 100 can more effectively train the policy neural network 120, e.g., because making use of proto-goal pruning causes the agent to more effectively explore the environment and results in higher-quality training data being added to the replay memory 140.

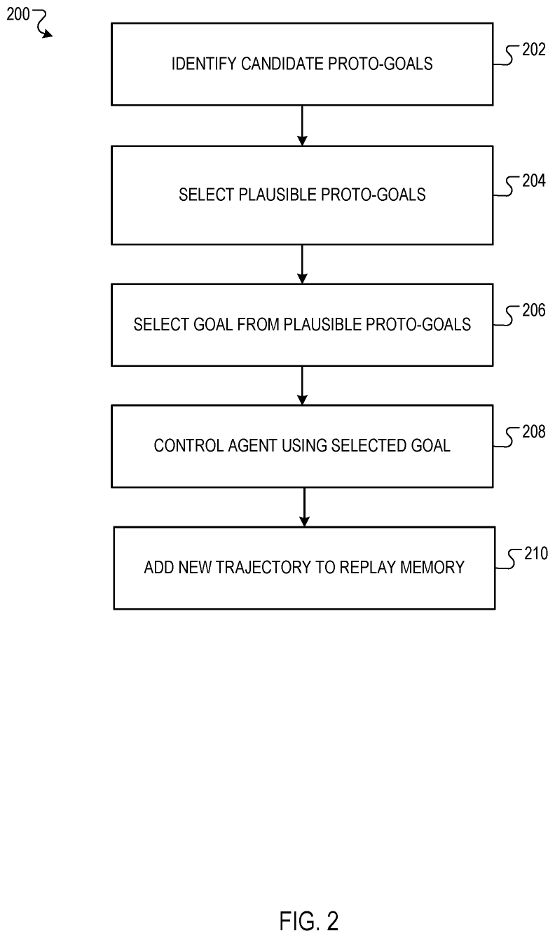

FIG. 2 is a flow diagram of an example process 200 for controlling the agent at a given time step during a task episode performed during the training of the policy neural network. For convenience, the process 200 will be described as being performed by a system of one or more computers located in one or more locations. For example, an action selection system, e.g., the action selection system 100 of FIG. 1, appropriately programmed in accordance with this specification, can perform the process 200.

In some cases, the system performs the process 200 at every iteration that occurs during training. In some other cases, the system performs the process 200 for some iterations that occur during training and performs another process for some other iterations.

In particular, optionally, at some other iterations during training, the system can control the agent conditioned on the default goal as would be done after training.

The system identifies, from a plurality of proto-goals that were achieved in transitions stored in the replay memory, a plurality of candidate proto-goals for the agent for the iteration (step 202).

For example, the system can consider, as a candidate proto-goal, each proto-goal that has been achieved at least once in all of the transitions in the replay memory or in a subset of the transitions, e.g., a randomly sampled subset or a most recently generated subset.

As another example, the system can consider, as a candidate proto-goal, each proto-goal that has been achieved at least a threshold number of times, where the threshold is greater than one, in all of the transitions in the replay memory or in a subset of the transitions, e.g., a randomly sampled subset or a most recently generated subset.

A proto-goal is achieved when the environment has the one or more particular properties corresponding to the proto-goal when in a given state. Thus, a proto-goal is achieved in a transition when the proto-goal is achieved in the state characterized by the observation in the transition.

The system can select, as plausible goals for the iteration, a plurality of the candidate proto-goals (step 204).

Generally, a “plausible” goal is one that the system has determined is reachable by the agent, i.e., that can be attained by the agent. Thus, “reachable” and “attainable” may be used interchangeably in this specification.

Optionally, the system can also require that plausible goals be a goal that the system has determined is controllable by the agent, i.e., so that the behavior of the agent influences whether the goal is achieved or not, rather than a goal that is not controllable by the agent, i.e., that is equally likely to be achieved regardless of the actions performed by the agent and regardless of whether the agent is attempting to achieve the goal or not.

That is, in some implementations, the system identifies, based on the transitions stored in the replay memory, a first subset of the proto-goals that (i) are controllable by the agent and (ii) are reachable by the agent and then designates this first subset as plausible goals.

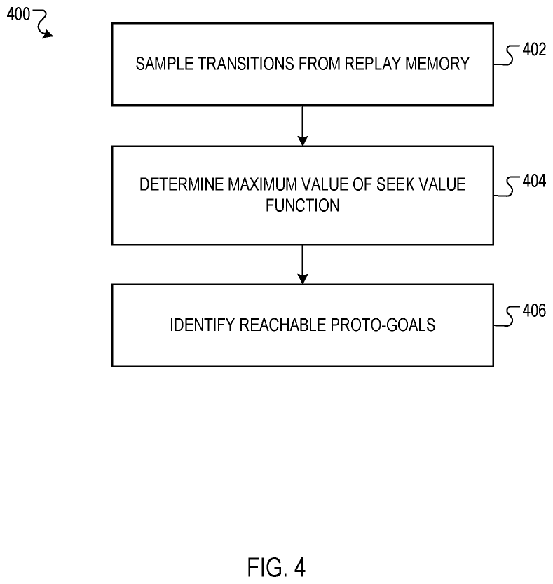

Identifying proto-goals that are reachable by the agent is described in more detail below with reference to FIG. 4.

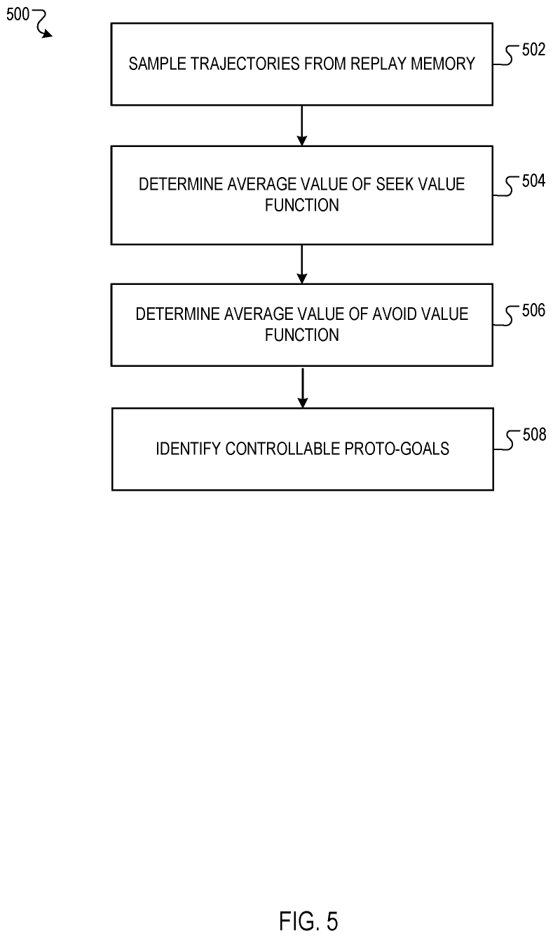

Identifying proto-goals that are controllable by the agent is described in more detail below with reference to FIG. 5.

Thus, the system “prunes” the candidate proto-goals to generate the plausible proto-goals. In other words, the system can refine the large space of proto-goals to a narrower space of proto-goals that are more likely to be relevant to the training of the policy neural network, e.g., to result in transitions being generated that improve the quality of the training.

The system selects a goal from the plurality of plausible goals (step 206).

The system can select a goal from the plurality of plausible goals in any of a variety of ways.

As one example, the system can randomly sample the goal from the plurality of plausible goals.

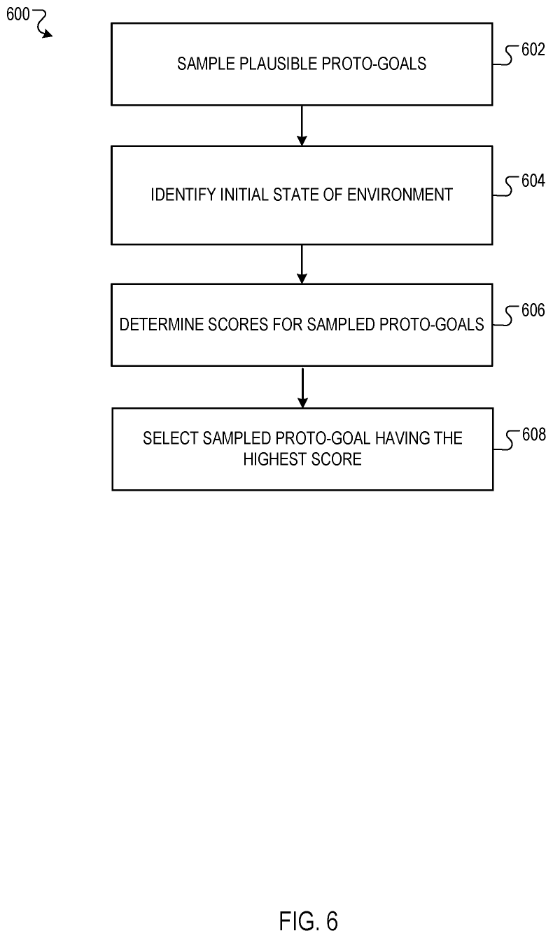

As another example, the system can use respective novelty measures for the plausible proto-goals to select the goal. This is described in more detail below with reference to FIG. 6.

The system controls the agent using the policy neural network conditioned on the selected goal to generate a new trajectory (step 208). For example, the system can control the agent until a termination criterion is satisfied, e.g., until the selected goal is achieved, until a maximum number of actions have been performed or a maximum number of observations have been received, until the environment reaches a terminal state, or until some other criterion is satisfied.

The new trajectory includes a sequence of transitions, data identifying the selected goal, i.e., the goal that was used to condition the policy neural network when the trajectory was generated, and a goal reward indicating whether the selected goal was achieved in the new trajectory. For example, the goal reward can be a binary reward that is equal to zero or negative one when the selected goal was not achieved and equal to one when the selected goal was achieved.

Optionally, the system can also receive, at each time step in the trajectory, a respective task reward and include the task rewards as part of the transitions in the trajectory.

The system then adds the new trajectory to the replay memory for use in training the policy neural network (step 210).

Because the trajectory includes both the goal reward for the selected goal and the task rewards, the system can use the trajectory to train the neural network both on task rewards, i.e., as if the trajectory had been generated with the policy neural network being conditioned on the default goal, and on the goal reward, i.e., with the policy neural network being conditioned on the selected goal. For example, the system can train on both the goal rewards and the task rewards by splitting the new trajectory into two trajectories, one that is labeled with goal rewards and one that is labeled with task rewards and then training on both trajectories using reinforcement learning.

In some implementations, the system can make use of re-labeling in order to augment the replay memory with additional trajectories without requiring any additional control of the agent. This can be useful, e.g., when controlling the agent can cause wear and tear on the agent or damage to the environment or when controlling the agent is computationally expensive.

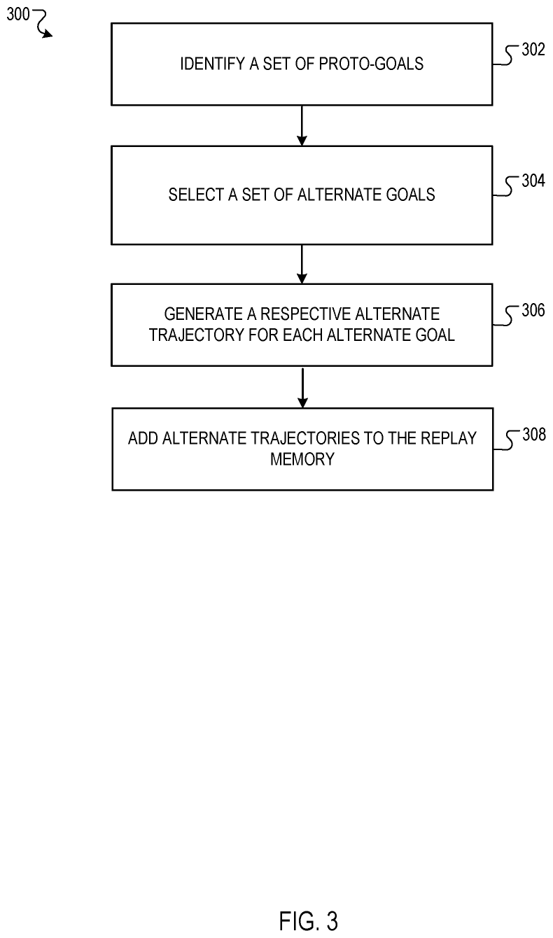

Performing re-labeling is described in more detail below with reference to FIG. 3.

As described above, at intervals during the training, the system samples one or more trajectories from the replay memory and trains the policy neural network on the sampled trajectories, e.g., through reinforcement learning.

The system can generally use any appropriate reinforcement learning technique to perform the training. Examples of such techniques include Q learning techniques, actor-critic techniques, policy gradient techniques, policy improvement techniques, and so on. In some implementations, the system can distribute the training across multiple actor computers that each generate trajectories and one or more learner computers that each repeatedly sample trajectories from the replay memory and then train the policy neural network on the sampled trajectories.

Thus, as training progresses, the control of the agent in step 208 is performed using improving versions of the policy neural network.

In some implementations, the set of proto-goals is determined before training, e.g., by a user of the system, and is held fixed throughout the training.

In some other implementations, an initial set of proto-goals is determined before training and the system can automatically adjust the initial set of proto-goals during training.

For example, the system can maintain a set of merging criteria, i.e. one or more criteria which, if the system determines that it/they are met by a certain plurality of the existing proto-goals, cause the system to initiate the definition of a new proto-goal as a combination of the plurality of existing proto-goals.

At intervals during the training, e.g., every time an iteration of the process 200 is performed or every Nth time the process 200 is performed, the system can determine whether any combination of two or more of the plausible proto-goals satisfy one or more of the merging criteria.

For example, the system can determine that the criteria are satisfied when at least two proto-goals in the current set of goals have been mastered by the agent, i.e., that the proto-goal is likely to be successfully achieved by the agent if the policy neural network is conditioned on the proto-goal.

As a particular example, the system can maintain, for each proto-goal, a count of a number of times the proto-goal has been achieved by the agent and a success ratio that indicates, of the last k times that the policy neural network has been conditioned on the proto-goal, the fraction of times the proto-goal has been attained.

The system can then determine that a given proto-goal has been mastered when the count for the given proto-goal exceeds a first threshold value and the success ratio for the given proto-goal exceeds a second threshold value.

When there are two or more proto-goals that the system has determined have been mastered, the system can generate a respective probability for each mastered proto-goal, e.g., by normalizing the success ratios for the mastered proto-goals, and then sample two mastered proto-goals from the resulting distribution as the two proto-goals that satisfy the merging criteria.

In response to determining that the one or more merging criteria have been satisfied for two or more of the plausible proto-goals, the system can generate a new proto-goal that is achieved (only) when all of the two or more plausible proto-goals have been achieved.

Thus, by repeatedly merging proto-goals, the system generates a combinatorically larger goal space with logical operations. As a result, the system places less burden on the design of the proto-goal space, because the initial space only needs to contain useful goal components, not the useful goals themselves. This is also a form of continual learning, with more complex or harder-to-reach goals continually being constructed out of existing ones during the training.

An example algorithm for merging proto-goals when the merging criteria are based on mastery is described in the below pseudo-code:

```
Inputs: Goal space [symbol]  , mapping of goals to counts
N : [symbol]    → [symbol]  , mapping of goals to the average success ratio
on the last 10 on-policy pursuits S : [symbol]   → [0, 1].
Hyperparameters: Mastery threshold κ.
  1: Mastered goals M:
      M = {g|g ∈ [symbol]  , N(g) ≥ 10, S(g) > κ}
  2: Convert the mastery scores to probabilities:
        $ℙ ( g ) = \frac{S ( g )}{{\sum }_{g} S ( g )} , ∀ g ∈ M .$
  3: Sample (without replacement) 2 goals from [symbol]  (g) : g₁, g₂.
  4: Create new proto-goal b = AND(g₁, g₂) and add it to the
    proto-goal space Bₜ.
  5: return Bₜ
```

FIG. 3 is a flow diagram of an example process 300 for performing re-labeling during the training of the policy neural network. For convenience, the process 300 will be described as being performed by a system of one or more computers located in one or more locations. For example, an action selection system, e.g., the action selection system 100 of FIG. 1, appropriately programmed in accordance with this specification, can perform the process 300.

The system can perform the process 300 after generating a new trajectory as described above in step 208.

The system identifies a set of proto-goals that includes each proto-goal that is identified in any of the transitions in the new trajectory (step 302). That is, the set includes, for each transition, any proto-goal that was achieved when the environment was in the state characterized by the observation in the transition.

The system selects, from the set that includes the proto-goals identified in any of the transitions in the new trajectory, a set of alternate goals for the new trajectory (step 304).

The system can select the alternate goals using any of a variety of techniques.

For example, the system can select each identified proto-goal in the set as an alternate goal.

As another example, the system can select a subset, e.g., a fixed number, of the identified proto-goals that the system determines will maximize expected learning progress of the policy neural network. For example, the system can sample a fixed number of the identified proto-goals proportional to the respective novelty measures for the identified proto-goals. Novelty measures are described in more detail below.

The system generates a respective alternate new trajectory for each alternate goal (step 306). The alternate new trajectory includes one or more of the transitions in the sequence of transitions, data identifying the alternate goal, and a goal reward indicating that the alternate goal was achieved in the alternate new trajectory. For example, the one or more transitions can be the transitions in the sequence starting from the beginning of the sequence and continuing until the first state at which the alternate goal was achieved.

The system adds the alternate new trajectories to the replay memory for use in training the policy neural network (step 308), i.e., in addition to the corresponding new trajectory that was generated by controlling the agent. Thus, the system can add the alternate new trajectories to improve the diversity of the trajectories in the replay memory and improve the training of the policy neural network without having to perform any additional control of the agent.

FIG. 4 is a flow diagram of an example process 400 for identifying reachable proto-goals. For convenience, the process 400 will be described as being performed by a system of one or more computers located in one or more locations. For example, an action selection system, e.g., the action selection system 100 of FIG. 1, appropriately programmed in accordance with this specification, can perform the process 400.

The system samples a plurality of transitions from the replay memory (step 402).

For each of the proto-goals, the system determines a maximum value of a seek value function for the proto-goal among the sampled plurality of transitions (step 404).

Generally, the seek value function for a given proto-goal maps an observation from an input transition to a seek value that indicates whether the proto-goal is reachable (also referred to as “achievable”) starting from the observation in the input transition, e.g., if the agent is attempting to achieve the proto-goal.

For example, the seek value can be an estimate of a time-discounted seek reward that will be received if the agent is controlled with the policy neural network conditioned on the proto-goal. The seek reward for a given state is a reward that is equal to one in the given state if the proto-goal is achieved and equal to zero otherwise.

The system can learn the seek value function in any of a variety of ways. Generally, the system can repeatedly perform the following for a given proto-goal: sample a plurality of trajectories from the replay memory, label each transition in the trajectory with a seek reward that identifies if the proto-goal is achieved in the corresponding state, and then learn the seek value function using target seek values computed using the seek rewards.

For example, to learn the seek value function during training in a computationally efficient manner, the system can reduce the value estimation to a linear function approximation problem by performing a least-squares policy iteration on trajectories in the replay buffer. In this example, the inputs to the approximation can be random projections of the observations into a smaller-dimensional space.

The system identifies each proto-goal that has a maximum seek value, i.e., a maximum value of the seek value function, that exceeds a threshold as being reachable by the agent (step 406). Thus, the system selects the proto-goals that are likely to be reachable from any one of the (sampled) transitions as being reachable.

FIG. 5 is a flow diagram of an example process 500 for identifying controllable proto-goals. For convenience, the process 500 will be described as being performed by a system of one or more computers located in one or more locations. For example, an action selection system, e.g., the action selection system 100 of FIG. 1, appropriately programmed in accordance with this specification, can perform the process 500.

The system samples a plurality of transitions from the replay memory (step 502). For example, these can be the same transitions as were sampled in step 402 or an independent sample of transitions from the replay memory.

For each of the proto-goals, the system determines an average value of the seek value function for the proto-goal among the sampled plurality of transitions (step 504).

For each of the proto-goals, the system determines an average value of an avoid value function for the proto-goal among the sampled plurality of transitions (step 506).

Generally, the avoid value function for a given proto-goal maps an observation from an input transition to an avoid value that indicates whether the proto-goal is avoidable starting from the observation in the input transition, e.g., if the agent is attempting to avoid the proto-goal.

For example, the avoid value can be an estimate of a time-discounted avoid reward that will be received if the agent is controlled with the policy neural network conditioned on the proto-goal.

The avoid reward for a given state is a reward that is equal to negative one in the given state if the proto-goal is achieved and equal to zero otherwise. This is unlike the seek reward, which is equal to one (instead of negative one) if the proto-goal is achieved.

The system can learn the avoid value function in any of a variety of ways. Generally, the system can repeatedly perform the following for a given proto-goal: sample a plurality of trajectories from the replay memory, label each transition in the trajectory with an avoid reward that identifies if the proto-goal is achieved in the corresponding state, and then learn the avoid value function using target avoid values computed using the seek rewards.

For example, to learn the avoid value function during training in a computationally efficient manner, the system can reduce the value estimation to a linear function approximation problem by performing a least-squares policy iteration (LSPI) on trajectories in the replay buffer. In this example, the inputs to the approximation can be random projections of the observations into a smaller-dimensional space.

The system identifies each proto-goal as either being controllable by the agent or not controllable by the agent based on the average values of the seek value function and the avoid value function for the proto-goal (step 508). For example, the system can identify a given proto-goal as being controllable by the agent when a difference between the average value of the seek value function and a negative of the average value for the avoid value function for the proto-goal is greater than a threshold. Thus, the system determines that a proto-goal is uncontrollable when the agent is (within a threshold) equally likely to achieve the proto-goal whether the agent is attempting to achieve the proto-goal or to avoid the proto-goal.

An example algorithm for selecting plausible proto-goals by first identifying reachable proto-goals and then identifying controllable proto-goals from the reachable proto-goals is described in the below pseudo-code:

| | |
|---|---|
| Inputs: Proto-goals observed so far Bₜ, replay buffer [symbol] . | [symbol] |
| Hyperparameters: Controllability threshold τ₁, reachability | [symbol] |
| threshold τ₂. | [symbol] |
| 1: Sample transitions from replay: s, a, s′~ [symbol] . | [symbol] |
| 2: Relabel transitions based on seek reward function: | |
| ${r}_{seek}^{g} = {R}_{seek} ( s , {s}^{′} , g ) , ∀ g ∈ {B}_{t} .$ | |
| 3: Relabel transitions based on avoid reward function: | |
| ${r}_{avoid}^{g} = {R}_{avoid} ( s , {s}^{′} , g ) , ∀ g ∈ {B}_{t} .$ | |
| 4: Train seek value-function for each proto-goal: | |
| ${V}_{seek}^{g} = LSPI ( s , a , {r}_{seek}^{g} , {s}^{′} ) , ∀ g ∈ {B}_{t} .$ | |
| 5: Train avoid value-function for each proto-goal: | |
| ${V}_{avoid}^{g} = LSPI ( s , a , {r}_{avoid}^{g} , {s}^{′} ) , ∀ g ∈ {B}_{t} .$ | |
| 6: Get the controllable proto-goals: | |
| $𝒞 = \{ g : {𝔼}_{s} [ {V}_{seek}^{g} ( s ) + {V}_{avoid}^{g} ( s ) ] < {τ}_{1} , ∀ g ∈ {B}_{t} \} .$ | |
| 7: Plausible ones are the sometimes-reachable subset: | |
| $𝒢 = \{ g : {max}_{s} {V}_{seek}^{g} ( s ) > {τ}_{2} , ∀ g ∈ 𝒞 \} .$ | — |
| 8: return plausible proto-goals [symbol] . | |

[symbol]

indicates data missing or illegible when filed

FIG. 6 is a flow diagram of an example process 600 for selecting a goal using novelty measures for proto-goals. For convenience, the process 600 will be described as being performed by a system of one or more computers located in one or more locations. For example, an action selection system, e.g., the action selection system 100 of FIG. 1, appropriately programmed in accordance with this specification, can perform the process 600.

The system samples a plurality of plausible proto-goals based on respective novelty measures for the plausible proto-goals (step 602).

The novelty measure for a given proto-goal measures how “novel” the proto-goal is, i.e., measures how infrequently the proto-goal has been achieved during training of the policy neural network. For example, the novelty measure can be based on a count of a number of times the plausible proto-goal has been achieved, e.g., in the transitions in the replay memory or throughout the training of the policy neural network. As a particular example, the novelty measure can be equal to one divided by the square root of the count.

The system can use the novelty measures to sample from the plausible proto-goals in any of a variety of ways.

As one example, the system can map the respective novelty measures for the plausible proto-goals to probabilities, e.g., by normalizing the novelty measures, and then sample according to the probabilities.

As another example, the system can compute a desirability score for each plausible proto-goal, map the plausible proto-goals to probabilities, e.g., by normalizing the desirability scores, and then sample according to the probabilities. For example, the desirability score can be based on the novelty measures for the proto-goal and the average task reward received for the proto-goal, i.e., the average task reward achieved on transitions when the proto-goal was also achieved. As a particular example, to favor proto-goals that both have high average task rewards and high novelty measures, the desirability score can be the sum of the novelty measure and the average task reward.

As another example, the plausible proto-goals can be partitioned into a plurality of partitions (proper, optionally non-overlapping, subsets of the plausible proto-goals) according to respective timescale estimates for each of the plausible proto-goals. The timescale estimate for a given proto-goal measures how long it takes, e.g., how many time steps it takes, to reach the proto-goal once the agent begins attempting to achieve the proto-goal. For example, the system can generate the respective timescale estimate for a given proto-goal as the average of the seek value function of the proto-goal across a plurality of transitions sampled from the replay memory. The system can then generate the partitions by dividing the goals in the goal space into different buckets (quintiles).

In this example, the system can sample a partition from the plurality of partitions, e.g., by sampling from a specified distribution over the partitions, and then sample a plurality of plausible proto-goals from the partition based on the respective novelty measures for the plausible proto-goals in the partition, e.g., by mapping the respective novelty measures or desirability scores for the plausible proto-goals in the partition to probabilities, e.g., by normalizing the novelty measures, and then sampling according to the probabilities. For example, the specified distribution over the partitions can be a uniform distribution or other appropriate distribution that assigns a respective probability to each partition.

The system identifies an initial state of the environment (step 604). That is, the system identifies the initial state of the environment from which the agent will begin acting to generate the new trajectory.

The system determines, for each sampled plausible proto-goal, a score that represents a reachability of the sampled plausible proto-goal from the initial state of the environment (step 606). That is, for any given sampled plausible proto-goal, the system determines a score that represents how likely it is that the agent can reach the proto-goal if the agent attempts to reach the proto-goal, i.e., if the agent is controlled while the policy neural network is conditioned on the proto-goal.

For example, the system can process the sampled plausible proto-goal and an observation characterizing the initial state using a value function estimator to generate an estimate of a value of being in the initial state to accomplishing the sampled plausible proto-goal. The value function estimator can be implemented as an additional head on the policy neural network and learned jointly with the remainder of the policy neural network or can be a separate model that is trained on the same data as the policy neural network.

The system selects, as the goal for the iteration, the sampled plausible proto-goal having a highest score (step 608). Thus, the system selects the “nearest” goal from the sampled plausible proto-goals.

An example algorithm for selecting a goal is described in the below pseudo-code:

| Inputs: Goal space [symbol] , current state sₜ | |
|---|---|
| Output: Goal to pursue at sₜ | |
| Hyperparameters: Number of timescale bins k, | |
| number of novel goals m, task reward probability | |
| pₜₐₛₖ. | |
| 1: | if random.random( ) < pₜₐₛₖ then |
| 2: | return gₜ = 0 |
| 3: | else |
| 4: | Bin goals [symbol] = { [symbol] ₁, ..., [symbol] ₖ} based on timescale. |
| 5: | Uniformly sample a bin from [symbol] : [symbol] ^{h} = {g₁, ..., gₙ}. |
| 6: | Sample (with replacement) a set G = {g₁, ..., gₘ} |
| | from [symbol] ^{h} based on novelty. |
| 7: | Pick nearest goal in G: gₜ = arg max_{g∈G} [V_{θ}(sₜ\|g)] |
| 8: | return gₜ |
| 9: | end if |

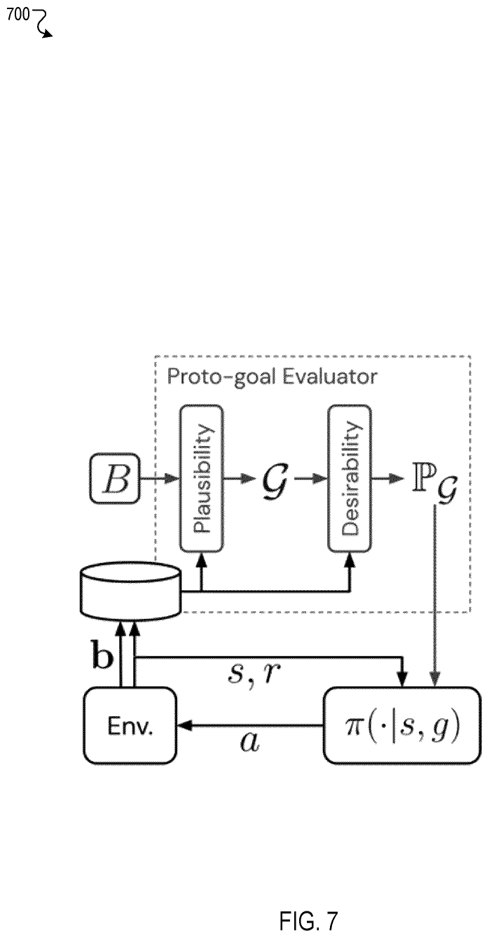

FIG. 7 shows an example of the operation of the system 100. In particular, as shown in FIG. 7, the system 100 includes a proto-goal evaluator (PGE) 700 that refines the large proto-goal space (B) using the trajectories in the replay buffer b in a computationally efficient manner by first filtering the proto-goals in the space B by plausibility to generate a set of plausible proto-goals G and then selecting one of the plausible proto-goals g based on desirability, e.g., based on the desirability scores described above.

Once the PGE 700 selects the proto-goal g, the system 100 controls the agent by selecting actions a using the policy neural network 7L conditioned on observations s and the proto-goal g. As a result, the agent receives task rewards r, which the system 100 uses to train the policy neural network through reinforcement learning.

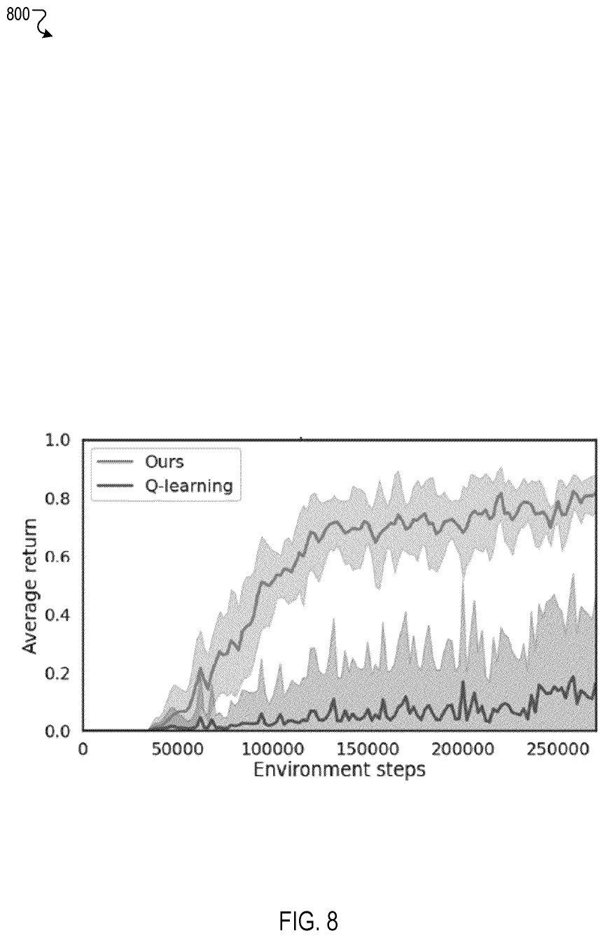

FIG. 8 shows an example 800 of the performance of the described techniques relative to a baseline technique on a difficult exploration task. In particular, FIG. 8 shows the performance of the described techniques, which train the policy neural network using proto-goal pruning as described above, relative to a baseline technique that trains the policy neural network though Q learning with an epsilon-greedy exploration policy. As can be seen from the Figure, as a result of the improved exploration afforded by making use of the described techniques, the described techniques achieve significantly better performance (in terms of average “return”) that the baseline technique.

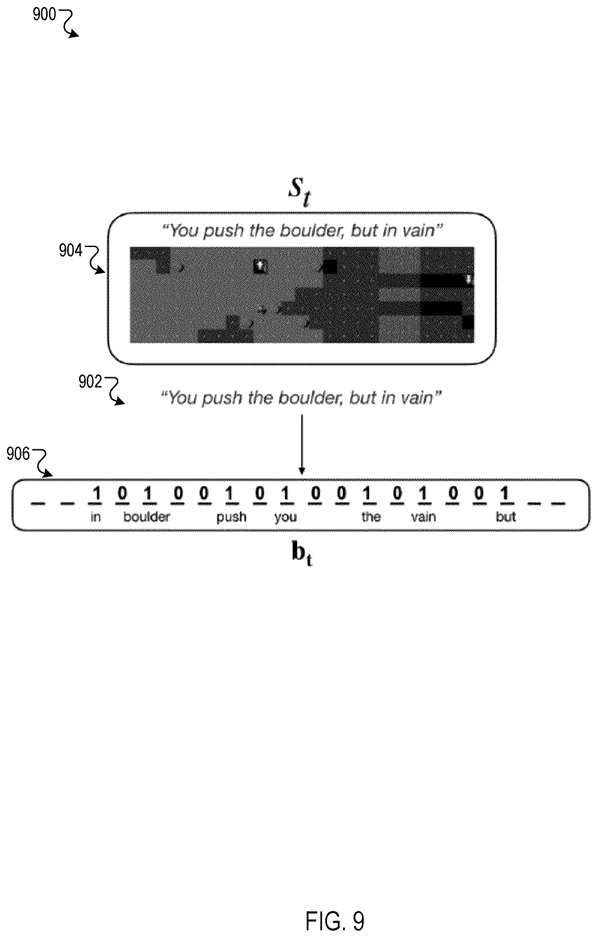

FIG. 9 shows an example 900 of the proto-goal space for an example task. In the example 900, the observations 904 that are received include text messages 902 (and images) and each proto-goal corresponds to a respective text token, e.g., to a respective word. Thus, as shown in FIG. 9, the system generates a vector bₜ 906 that identifies which proto-goals were achieved in the corresponding state by setting each entry of the vector that corresponds to a text token (word) that occurred in the text message 902 to a value of 1 and setting each other entry to 0. Thus, all proto-goals that correspond to entries that have 1 in the vector 906 were achieved in the state at time t and all others were not.

FIG. 10 shows an example architecture 1000 of the policy neural network 120 when the observations received by the system include images.

Generally, the policy neural network 120 can have any appropriate architecture that allows the policy neural network 120 to map observations and goal vectors to a policy output. In particular, the policy neural network can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

FIG. 10 shows one example 1000 of the policy neural network architecture.

In the example of FIG. 10, the policy neural network includes a first subnetwork that processes an input observation to generate a belief representation and a policy head that processes the belief representation to generate the policy output Q. In the example of FIG. 10, the policy head is a multi-layer perceptron (MLP).

The belief representation is an internal representation of the state of the environment at the time step and, optionally, of previous states of the environment at previous time steps. Generally, the belief representation is a tensor, e.g., a vector, matrix, or feature map, of numerical values that has a fixed dimensionality.

For example, in the example of FIG. 10, the first subnetwork includes an encoder neural network that processes the observation to generate an encoded representation. While the encoder neural network is shown in FIG. 10 as a convolutional neural network (CNN), the encoder neural network can have any appropriate architecture that allows the neural network encode observations that are received as input. For example, the encoder neural network can be a convolutional neural network, a Transformer neural network, a multi-layer perceptron (MLP), and so on.

The first subnetwork can also include a recurrent neural network, e.g., a long-short term memory (LSTM) neural network, which processes the encoded representation and a previous internal state of the recurrent neural network to update the previous internal state and to generate the belief representation. In the example of FIG. 10, the recurrent neural network also processes the previous action aₜ₋₁ and the previous goal reward rₜ₋₁. Thus, because the first subnetwork includes a recurrence mechanism, e.g., because of the use of the internal state that acts as a “memory” of previous states, the belief representation includes information about the current state of the environment and previous states of the environments.

The policy neural network also includes a second subnetwork (a CNN or MLP torso) that processes the goal vector to generate an encoded representation of the goal vector.

The policy head then processes the belief representation and the encoded representation of the goal vector to generate the policy output. A “head,” as used in this specification, is a collection of one or more neural network layers. Thus, the policy head can have any appropriate architecture that allows the head to map the belief representation to a policy output. For example, the policy head can be a multi-layer perceptron (MLP) as in the example of FIG. 10 or a different type of feedforward neural network.

Some examples of the types of agents the system can control now follow.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example, in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example, in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example, the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example, the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general, the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example, a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor.

In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general, the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example, a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example, in the case of a task to control, e.g., minimize, use of a resource, such as a task to control use of electrical power or water, the metric may comprise any metric of use of the resource.

In some implementations the environment is the real-world environment of a power generation facility e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example, a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example, rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example, the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example, the system may be partly trained using a simulation of a mechanical agent in a simulation of a particular real-world environment, and afterwards deployed to control the real mechanical agent in the particular real-world environment. Thus, in such cases the observations of the simulated environment relate to the real-world environment, and the selected actions in the simulated environment relate to actions to be performed by the mechanical agent in the real-world environment.

As another example, in some implementations the agent comprises a digital assistant such as a smart speaker, smart display, or other device and the actions performed by the agent are outputs generated by the digital assistant in response to inputs from a human user that specify the task to be performed. The outputs may be provided using natural language, e.g., on a display and/or using a speech synthesis subsystem of the digital assistant. Visual, e.g., video, and/or audio observations of the user may be captured, e.g., using the digital assistant.

Optionally, in any of the above implementations, the observation at any given time step may include data from a previous time step that may be beneficial in characterizing the environment, e.g., the action performed at the previous time step, the reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

Aspects of the present disclosure may be as set out in the following clauses:

Clause 1. A method for controlling an agent interacting with an environment to perform a task, the method comprising, at each of a plurality of iterations:
identifying, from a plurality of proto-goals that were achieved in transitions stored in a replay memory, a plurality of candidate proto-goals for the agent;
selecting, as plausible goals for the iteration, a plurality of the candidate proto-goals; selecting a goal from the plurality of plausible goals;
controlling the agent using a policy neural network conditioned on the selected goal to generate a new trajectory that comprises a sequence of transitions, data identifying the selected goal, and a goal reward indicating whether the selected goal was achieved in the new trajectory, each transition comprising:
   (i) an observation characterizing a state of the environment,
   (ii) data identifying each proto-goal that was achieved when the environment was in the state, and
   (iii) an action performed by the agent in response to the observation; and adding the new trajectory to the replay memory for use in training the policy neural network.

Clause 2. The method of clause 1, further comprising:
sampling one or more trajectories from the replay memory; and
training the policy neural network on the sampled trajectories.

Clause 3. The method of clause 1 or clause 2, further comprising:
selecting, from a set comprising each proto-goal identified in any of the transitions in the new trajectory, a plurality of alternate goals for the new trajectory;
generating a respective alternate new trajectory for each alternate goal that includes one or more of the sequence of transitions, data identifying the alternate goal, and a goal reward indicating that the alternate goal was achieved in the alternate new trajectory; and
adding the alternate new trajectories to the replay memory for use in training the policy neural network.

Clause 4. The method of any preceding clause, wherein selecting, as plausible goals for the iteration, a plurality of the candidate proto-goals comprises:
identifying, based on the transitions stored in the replay memory, a first subset of the proto-goals that are controllable by the agent and are reachable by the agent as plausible goals.

Clause 5. The method of clause 4, wherein identifying, based on the transitions stored in the replay memory, a first subset of the proto-goals that are controllable by the agent and are reachable by the agent as plausible goals comprises:
sampling a plurality of transitions from the replay memory;
for each of the proto-goals, determining a maximum value of a seek value function for the proto-goal among the sampled plurality of transitions; and
identifying each proto-goal having a maximum seek value that exceeds a threshold as being reachable by the agent.

Clause 6. The method of clause 4 or clause 5, wherein identifying, based on the transitions stored in the replay memory, a first subset of the proto-goals that are controllable by the agent and are reachable by the agent as plausible goals comprises:
sampling a plurality of transitions from the replay memory;
for each of the proto-goals, determining an average value of a seek value function for the proto-goal among the sampled plurality of transitions and an average value of an avoid value function for the proto-goal among the sampled plurality of transitions, wherein the seek value function maps an observation from an input transition to a seek value that indicates whether the proto-goal is achievable starting from the observation in the input transition; and
identifying each proto-goal as either being controllable by the agent or not controllable by the agent based on the average values of the seek value function and the avoid value function for the proto-goal.

Clause 7. The method of clause 6, wherein identifying each proto-goal as either being controllable by the agent or not controllable by the agent based on the average values of the seek value function and the avoid value function for the proto-goal comprises:
identifying the proto-goal as being controllable by the agent when a difference between the average value of the seek value function and a negative of the average value for the avoid value function for the proto-goal is greater than a threshold.

Clause 8. The method of any preceding clause, wherein selecting a goal from the plurality of plausible goals comprises:
sampling a plurality of plausible proto-goals based on respective novelty measures for the plausible proto-goals;
identifying an initial state of the environment;
determining, for each sampled plausible proto-goal, a score that represents a reachability of the sampled plausible proto-goal from the initial state of the environment; and
selecting, as the goal for the iteration, the sampled plausible proto-goal having a highest score.

Clause 9. The method of clause 8, wherein the respective novelty measure for each plausible proto-goal is based on a count of a number of times the plausible proto-goal has been achieved in the transitions in the replay memory.

Clause 10. The method of clause 8 or clause 9, wherein the plausible proto-goals are partitioned into a plurality of partitions according to respective timescale estimates for each of the plausible proto-goals and wherein sampling a plurality of plausible proto-goals based on respective novelty measures for the plausible proto-goals comprises:
sampling a partition from the plurality of partitions; and
sampling a plurality of plausible proto-goals from the partition based on respective novelty measures for the plausible proto-goals in the partition.

Clause 11. The method of clause 10, wherein sampling a partition from the plurality of partitions comprises:
sampling the partition from a uniform distribution over the plurality of partitions.

Clause 12. The method of any one of clauses 8-11, wherein determining, for each sampled plausible proto-goal, a score that represents a reachability of the sampled plausible proto-goal from the initial state of the environment comprises:
processing the sampled plausible proto-goal and an observation characterizing the initial state using a value function estimator to generate an estimate of a value of being in the initial state to accomplishing the sampled plausible proto-goal.

Clause 13. The method of any preceding clause, further comprising:
determining that one or more merging criteria have been satisfied for two or more of the plausible proto-goals; and
in response, generating a new proto-goal that is achieved when all of the two or more plausible proto-goals have been achieved.

Clause 14. The method of any preceding clause, wherein the agent is a mechanical agent and the environment is a real-world environment.

Clause 15. The method of clause 14, wherein the agent is a robot.

Clause 16. The method of any preceding clause, wherein the environment is a real-world environment of a service facility comprising a plurality of items of electronic equipment and the agent is an electronic agent configured to control operation of the service facility.

Clause 17. The method of any preceding clause, wherein the environment is a real-world manufacturing environment for manufacturing a product and the agent comprises an electronic agent configured to control a manufacturing unit or a machine that operates to manufacture the product.

Clause 18. The method of any preceding clause, wherein the environment is a simulation of a real-world environment and wherein the method further comprises:
after training the policy neural network, controlling a real-world agent in the real-world environment using the policy neural network.

Clause 19. The method of any preceding clause, wherein the environment is a simulation of a real-world environment and wherein the method further comprises:
after training the policy neural network, providing data specifying the policy neural network for use in controlling a real-world agent in the real-world environment.

Clause 20. The method of any preceding clause, wherein the agent is a digital assistant and wherein actions performed by the agent include outputs that are provided by the digital assistant to a user.

Clause 21. The method of clause 20, wherein the outputs include one or more of:
text displayed to a user in a user interface of the digital assistant;
an image displayed to the user in the user interface of the digital assistant; or
speech output through one or more speakers of the digital assistant.

Clause 22. The method of any preceding clause, wherein the proto-goals include one or more proto-goals that are each associated with a respective corresponding criterion and that are each achieved in a given state of the environment when an output of a machine learning model generated by processing a given observation characterizing the given state of the environment satisfies the corresponding criterion.

Clause 23. The method of any preceding clause, wherein the proto-goals include one or more proto-goals that are each associated with a corresponding object attribute and that are each achieved in a given state of the environment when an object having the corresponding object attribute is detected in the environment when the environment is in the given state.

Clause 24. The method of any preceding clause, wherein the proto-goals include one or more proto-goals that are each associated with a corresponding entity and that are each achieved in a given state of the environment when the corresponding entity is referred to in text that is received from the environment when the environment is in the given state.

Clause 25. The method of any preceding clause, further comprising, at each of a further plurality of iterations:
selecting, as a goal for the iteration, a default goal that indicates that task rewards for the task should be maximized;
controlling the agent using a policy neural network conditioned on the default goal to generate a further new trajectory that comprises a sequence of transitions and a respective task reward for each of one or more of the transitions; and
adding the further new trajectory to the replay memory for use in training the policy neural network.

Clause 26. A system comprising:
one or more computers; and
one or more storage devices communicatively coupled to the one or more computers, wherein the one or more storage devices store instructions that, when executed by the one or more computers, cause the one or more computers to perform the operations of the respective method of any one of clauses 1-25.

Clause 27. One or more non-transitory computer storage media storing instructions that when executed by one or more computers cause the one or more computers to perform the operations of the respective method of any one of clauses 1-25.

1. A method for controlling an agent interacting with an environment to perform a task, the method comprising, at each of a plurality of iterations:
identifying, from a plurality of proto-goals that were achieved in transitions stored in a replay memory, a plurality of candidate proto-goals for the agent;
selecting, as plausible goals for the iteration, a plurality of the candidate proto-goals;
selecting a goal from the plurality of plausible goals; and
controlling the agent using a policy neural network conditioned on the selected goal to generate a new trajectory that comprises a sequence of transitions, data identifying the selected goal, and a goal reward indicating whether the selected goal was achieved in the new trajectory, each transition comprising:
(i) an observation characterizing a state of the environment,
(ii) data identifying each proto-goal that was achieved when the environment was in the state, and
(iii) an action performed by the agent in response to the observation.

2. The method of claim 1, further comprising:
adding the new trajectory to the replay memory for use in training the policy neural network.

3. The method of claim 2, further comprising:
sampling one or more trajectories from the replay memory; and
training the policy neural network on the sampled trajectories.

4. The method of claim 2, further comprising:
selecting, from a set comprising each proto-goal identified in any of the transitions in the new trajectory, a plurality of alternate goals for the new trajectory;
generating a respective alternate new trajectory for each alternate goal that includes one or more of the sequence of transitions, data identifying the alternate goal, and a goal reward indicating that the alternate goal was achieved in the alternate new trajectory; and
adding the alternate new trajectories to the replay memory for use in training the policy neural network.

5. The method of claim 1, wherein selecting, as plausible goals for the iteration, a plurality of the candidate proto-goals comprises:
identifying, based on the transitions stored in the replay memory, a first subset of the proto-goals that are controllable by the agent and are reachable by the agent as plausible goals.

6. The method of claim 5, wherein identifying, based on the transitions stored in the replay memory, a first subset of the proto-goals that are controllable by the agent and are reachable by the agent as plausible goals comprises:
sampling a plurality of transitions from the replay memory;
for each of the proto-goals, determining a maximum value of a seek value function for the proto-goal among the sampled plurality of transitions, wherein the seek value function maps an observation from an input transition to a seek value that indicates whether the proto-goal is reachable starting from the observation in the input transition; and
identifying each proto-goal having a maximum seek value that exceeds a threshold as being reachable by the agent.

7. The method of claim 5, wherein identifying, based on the transitions stored in the replay memory, a first subset of the proto-goals that are controllable by the agent and are reachable by the agent as plausible goals comprises:
sampling a plurality of transitions from the replay memory;
for each of the proto-goals, determining an average value of a seek value function for the proto-goal among the sampled plurality of transitions and an average value of an avoid value function for the proto-goal among the sampled plurality of transitions; and
identifying each proto-goal as either being controllable by the agent or not controllable by the agent based on the average values of the seek value function and the avoid value function for the proto-goal.

8. The method of claim 7, wherein identifying each proto-goal as either being controllable by the agent or not controllable by the agent based on the average values of the seek value function and the avoid value function for the proto-goal comprises:
identifying the proto-goal as being controllable by the agent when a difference between the average value of the seek value function and a negative of the average value for the avoid value function for the proto-goal is greater than a threshold.

9. The method of claim 1, wherein selecting a goal from the plurality of plausible goals comprises:
sampling a plurality of plausible proto-goals based on respective novelty measures for the plausible proto-goals;
identifying an initial state of the environment;
determining, for each sampled plausible proto-goal, a score that represents a reachability of the sampled plausible proto-goal from the initial state of the environment; and
selecting, as the goal for the iteration, the sampled plausible proto-goal having a highest score.

10. The method of claim 9, wherein the respective novelty measure for each plausible proto-goal is based on a count of a number of times the plausible proto-goal has been achieved in the transitions in the replay memory.

11. The method of claim 9, wherein the plausible proto-goals are partitioned into a plurality of partitions according to respective timescale estimates for each of the plausible proto-goals and wherein sampling a plurality of plausible proto-goals based on respective novelty measures for the plausible proto-goals comprises:
sampling a partition from the plurality of partitions; and
sampling a plurality of plausible proto-goals from the partition based on respective novelty measures for the plausible proto-goals in the partition.

12. The method of claim 11, wherein sampling a partition from the plurality of partitions comprises:
sampling the partition from a uniform distribution over the plurality of partitions.

13. The method of claim 9, wherein determining, for each sampled plausible proto-goal, a score that represents a reachability of the sampled plausible proto-goal from the initial state of the environment comprises:
processing the sampled plausible proto-goal and an observation characterizing the initial state using a value function estimator to generate an estimate of a value of being in the initial state to accomplishing the sampled plausible proto-goal.

14. The method of claim 1, further comprising:
determining that one or more merging criteria have been satisfied for two or more of the plausible proto-goals; and
in response, generating a new proto-goal that is achieved when all of the two or more plausible proto-goals have been achieved.

15. The method of claim 1, wherein the agent is a mechanical agent and the environment is a real-world environment.

16. The method of claim 15, wherein the agent is a robot.

17. The method of claim 1, wherein the environment is a real-world environment of a service facility comprising a plurality of items of electronic equipment and the agent is an electronic agent configured to control operation of the service facility.

18. The method of claim 1, wherein the environment is a real-world manufacturing environment for manufacturing a product and the agent comprises an electronic agent configured to control a manufacturing unit or a machine that operates to manufacture the product.

19. The method of claim 1, wherein the environment is a simulation of a real-world environment and wherein the method further comprises:
after training the policy neural network, controlling a real-world agent in the real-world environment using the policy neural network.

20. The method of claim 1, wherein the environment is a simulation of a real-world environment and wherein the method further comprises:
after training the policy neural network, providing data specifying the policy neural network for use in controlling a real-world agent in the real-world environment.

21. The method of claim 1, wherein the agent is a digital assistant and wherein actions performed by the agent include outputs that are provided by the digital assistant to a user.

22. The method of claim 21, wherein the outputs include one or more of:
text displayed to a user in a user interface of the digital assistant;
an image displayed to the user in the user interface of the digital assistant; or
speech output through one or more speakers of the digital assistant.

23. The method of claim 1, wherein the proto-goals include one or more proto-goals that are each associated with a respective corresponding criterion and that are each achieved in a given state of the environment when an output of a machine learning model generated by processing a given observation characterizing the given state of the environment satisfies the corresponding criterion.

24. The method of claim 1, wherein the proto-goals include one or more proto-goals that are each associated with a corresponding object attribute and that are each achieved in a given state of the environment when an object having the corresponding object attribute is detected in the environment when the environment is in the given state.

25. The method of claim 1, wherein the proto-goals include one or more proto-goals that are each associated with a corresponding entity and that are each achieved in a given state of the environment when the corresponding entity is referred to in text that is received from the environment when the environment is in the given state.

26. The method of claim 1, further comprising, at each of a further plurality of iterations:
selecting, as a goal for the iteration, a default goal that indicates that task rewards for the task should be maximized;
controlling the agent using a policy neural network conditioned on the default goal to generate a further new trajectory that comprises a sequence of transitions and a respective task reward for each of one or more of the transitions; and
adding the further new trajectory to the replay memory for use in training the policy neural network.

27. A system comprising:
one or more computers; and
one or more storage devices communicatively coupled to the one or more computers, wherein the one or more storage devices store instructions that, when executed by the one or more computers, cause the one or more computers to perform operations for controlling an agent interacting with an environment to perform a task, the operations comprising, at each of a plurality of iterations;
identifying, from a plurality of proto-goals that were achieved in transitions stored in a replay memory, a plurality of candidate proto-goals for the agent;
selecting, as plausible goals for the iteration, a plurality of the candidate proto-goals;
selecting a goal from the plurality of plausible goals; and
controlling the agent using a policy neural network conditioned on the selected goal to generate a new trajectory that comprises a sequence of transitions, data identifying the selected goal, and a goal reward indicating whether the selected goal was achieved in the new trajectory, each transition comprising:
(i) an observation characterizing a state of the environment,
(ii) data identifying each proto-goal that was achieved when the environment was in the state, and
(iii) an action performed by the agent in response to the observation.

28. One or more non-transitory computer storage media storing instructions that when executed by one or more computers cause the one or more computers to perform operations for controlling an agent interacting with an environment to perform a task, the operations comprising, at each of a plurality of iterations:
identifying, from a plurality of proto-goals that were achieved in transitions stored in a replay memory, a plurality of candidate proto-goals for the agent;
selecting, as plausible goals for the iteration, a plurality of the candidate proto-goals;
selecting a goal from the plurality of plausible goals; and
controlling the agent using a policy neural network conditioned on the selected goal to generate a new trajectory that comprises a sequence of transitions, data identifying the selected goal, and a goal reward indicating whether the selected goal was achieved in the new trajectory, each transition comprising:
(i) an observation characterizing a state of the environment,
(ii) data identifying each proto-goal that was achieved when the environment was in the state, and
(iii) an action performed by the agent in response to the observation.
